(19) United States
(12) Patent Application Publication
(10) Pub. No.: US 2002/0040391 A1
(43) Pub. Date: Apr. 4, 2002

(54) Server farm formed of systems on a chip

(76) Inventors: David Chaiken, Menlo Park, CA (US); Mark J. Foster, Palo Alto, CA (US)

Correspondence Address: GLENN PATENT GROUP, 3475 EDISON WAY, SUITE L, MENLO PARK, CA, 94025, US

(21) Appl. No.: 09/910,096

(22) Filed: Jul. 19, 2001

Related U.S. Application Data
(63) Continuation-in-part of application No. 09/679,115, filed on Oct. 4, 2000.

(51) Int. Cl. G06F 15/177; G06F 15/16

(52) U.S. Cl. 709/220; 709/250

(57) ABSTRACT

A network architecture is provided in which a server farm is assembled with systems-on-a-chip, each of which implements one or more integrated standard or other network interfaces. The standard network interface of a system-on-a-chip is connected point-to-point to the standard network interface on another system-on-a-chip. The configuration disclosed herein eliminates the need for standard network opponents when assembling the server farm, resulting in significant savings both in terms of cost and space.

### BACKGROUND OF THE INVENTION

1. Technical Field

The invention relates to computer networks. More particularly, the invention relates to a server farm formed of systems on a chip.

2. Description of the Prior Art

A standard data communications network is a widely used system for connecting computing systems together. For example, the Ethernet standard is used for communication between millions of computers. FIG. 1 is a block schematic diagram of a data communications network 10 in which an Ethernet network 12 provides a communications medium for computers and workstations 14-16, servers 17, and other devices that have a network identity, such as printers 18.

A standard networking component is a device whose primary purpose is implementing a standard data communications network. For example, an Ethernet switch is a standard networking component. A Category 5 cable is also a Standard Networking Component. In FIG. 2, an Ethernet switch 21 and Category 522 cables are used to implement an Ethernet network.

A server is a single computer with one or more processors that provides digital information or computation services on a standard data communications network. A server is shown highlighted in FIG. 3.

A server farm is a system composed of a number of servers, connected by a standard communications network. By assembling a server farm, a large information service can scale to support hundreds, thousands, or millions of people. Examples of a companies that have a huge server-to-server farm include Google, Inktomi, and AltaVista, which are Internet search engines that assemble large numbers of machines to provide Internet search services. Many digital information and computation services assemble server farms by purchasing individual servers and using standard networking components to allow the servers to communicate. FIG. 4 replaces the server in FIG. 3 with a server farm 40.

A standard network interface consists of logic on an integrated circuit that connects the circuit and associated elements to a standard data communications network. For example, each processor integrated circuit used in the AgileTV engine, manufactured by AgileTV of Menlo Park, Calif., has three standard (Ethernet) network interfaces. These three standard network interfaces are capable of connecting to Ethernet networks. The three standard network interfaces on the BCM12500 integrated circuit (manufactured by Broadcom of Irvine, Calif. and used in the AgileTV engine) are also capable of non-standard networking modes, but they are considered to be standard network interfaces, even when they are operating in a non-standard mode. FIG. 5 shows a printed circuit board 50, which includes a power source 51, a physical interface 58, a memory 59, and a BCM12500 integrated circuit 523. The essential components of the BCM12500 integrated circuit 50 include a processors 54, 55, and Ethernet interfaces 53, 56, 57. While the discussion herein includes the BCM12500 interface/processor, those skilled in the art will appreciate that other such devices are known and readily available.

A system-on-a-chip is a single integrated circuit that implements at least one processor and that provides one or more standard network interfaces. For example, the BCM12500 integrated circuit is a system-on-a-chip. Thus, a server could consist of a single printed circuit board populated with a single system-on-a-chip, power circuitry, memory, and the circuitry and connectors required to implement a physical network connection, for example, as shown on FIG. 5.

Given the increasing need for bandwidth and processing power and the increase in applications for server farms, it would be desirable to provide a server farm constructed of systems-on-a-chip. It would be further advantageous to provide a network architecture that eliminates the need for standard network opponents when assembling the server farm, especially where such architecture results in significant savings both in terms of cost and space.

### SUMMARY OF THE INVENTION

The invention provides a network architecture in which a server farm is assembled with systems-on-a-chip, each of which implements one or more integrated standard network interfaces. The standard network interface of a system-on-a-chip is connected point-to-point to the standard network interface on another system-on-a-chip, although other interconnection schemes are possible with regard to alternative implementations of the invention. The configuration disclosed herein eliminates the need for standard network opponents when assembling the server farm, resulting in significant savings both in terms of cost and space.

### BRIEF DESCRIPTION OF THE DRAWINGS

FIG. 1 is a block schematic diagram showing a standard data communications network;

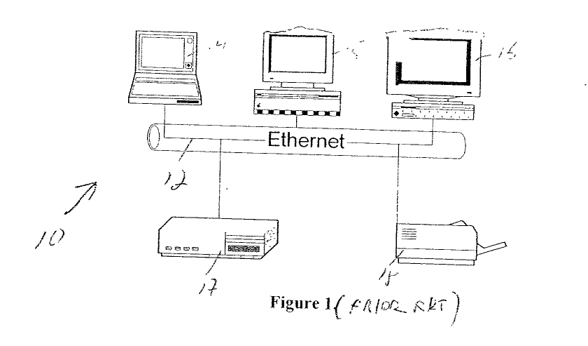

FIG. 2 is a block schematic diagram showing an Ethernet switch and Category 5 cables used to implement an Ethernet network;

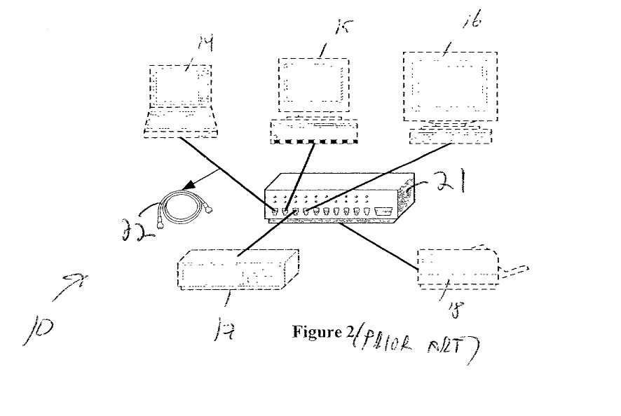

FIG. 3 is a block schematic diagram showing a standard data communications network in which the server component is highlighted;

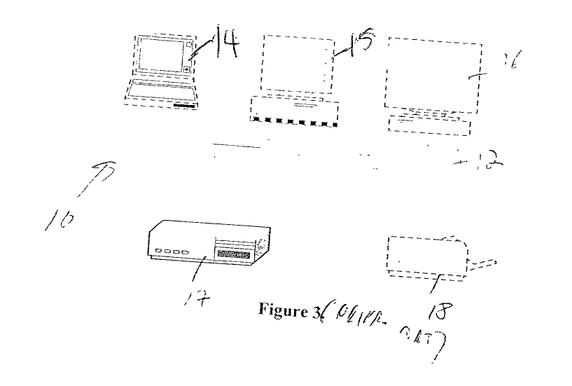

FIG. 4 is a block schematic diagram showing a standard data communications network, in which the server component is replaced with a server farm;

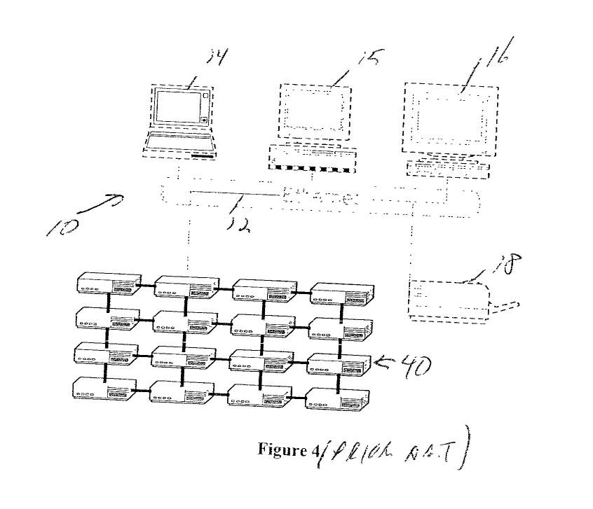

FIG. 5 is a block schematic diagram showing a standard communications network in which the server component is replaced by a system-on-a-chip;

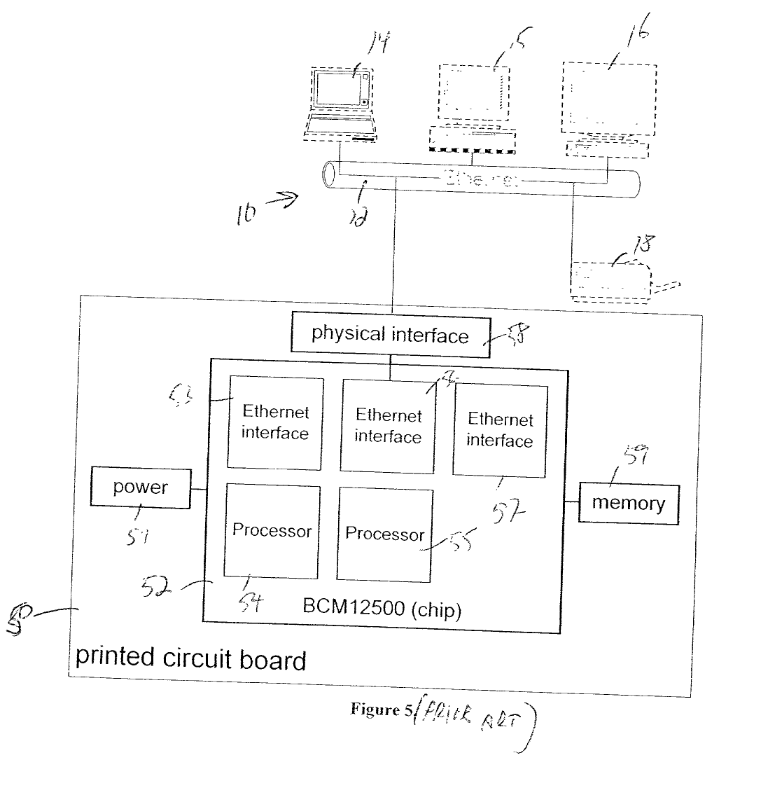

FIG. 6 is a block schematic diagram showing a small server farm according to the invention; and

FIG. 7 is a block schematic diagram showing a PLEX implementation of a server farm according to the invention.

### DETAILED DESCRIPTION OF THE INVENTION

The invention provides a network architecture in which a server farm is assembled with systems-on-a-chip, each of which implements one or more integrated standard or other network interfaces. The network interface of a system-on-a-chip is connected via an interconnect scheme, such as point-to-point, to the network interface on another system-on-a-chip. The network interface in the presently preferred embodiment of the invention is a standard network interface, e.g. Ethernet, but may be any standard or non-standard interface (see, for example, M. Foster, Multi-Dimensional Integrated Circuit Connection Network Using LDT,copending U.S. patent application Ser. No. ______, filed).

The configuration disclosed herein eliminates the need for standard network opponents when assembling the server farm, resulting in significant savings both in terms of cost and space. Thus, a key aspect of the invention is the recognition that commodity processors having standard network interface components, e.g. commodity system-on-a-chip processors (such as those manufactured by Broadcom, Inc. of Irvine, Calif. and others) can be connected in a very powerful but inexpensive way to implement, for example, a server farm.

In the presently preferred embodiment of the invention, the standard network interface provided by systems-on-a-chip are interconnected point-to-point on a common substrate, e.g. on the circuit board. Such interconnection may also be provided by connectors, for example via a motherboard or multi-chip module.

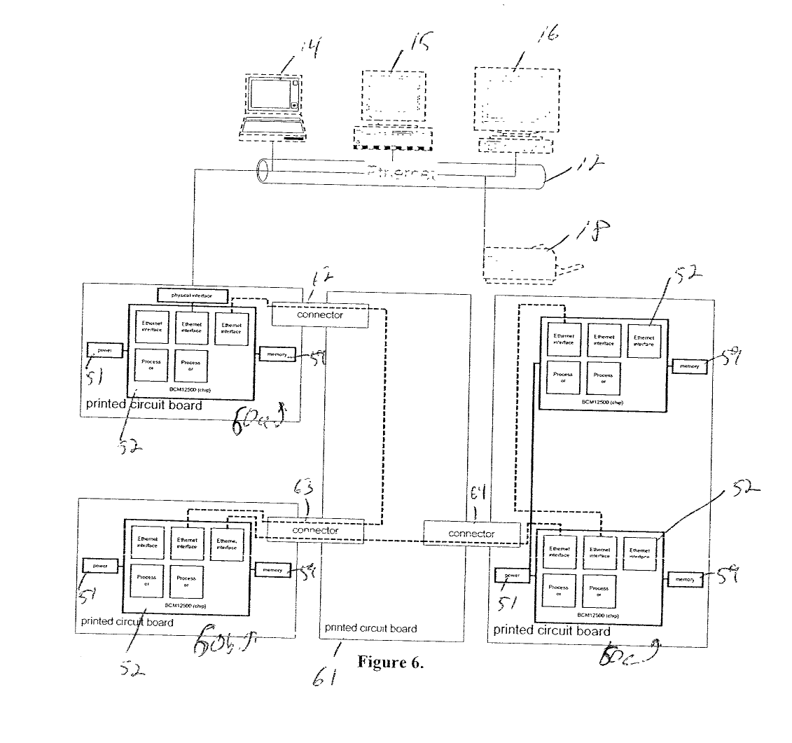

FIG. 6 is a block schematic diagram showing a small server farm according to the invention. The server farm shown in FIG. 6 is embodied in the AgileTV engine, manufactured by AgileTV of Menlo Park, Calif., that uses a back plane in which communication between systems-on-chip is conducted via the back plane 61 through corresponding connectors 62-64. In this way, this embodiment of the invention eliminates the physical interfaces that are required to establish communications between servers, i.e. to the outside world. Thus, the invention eliminates the cables and standard networking components, such as Ethernet switches, the are required by known server farms.

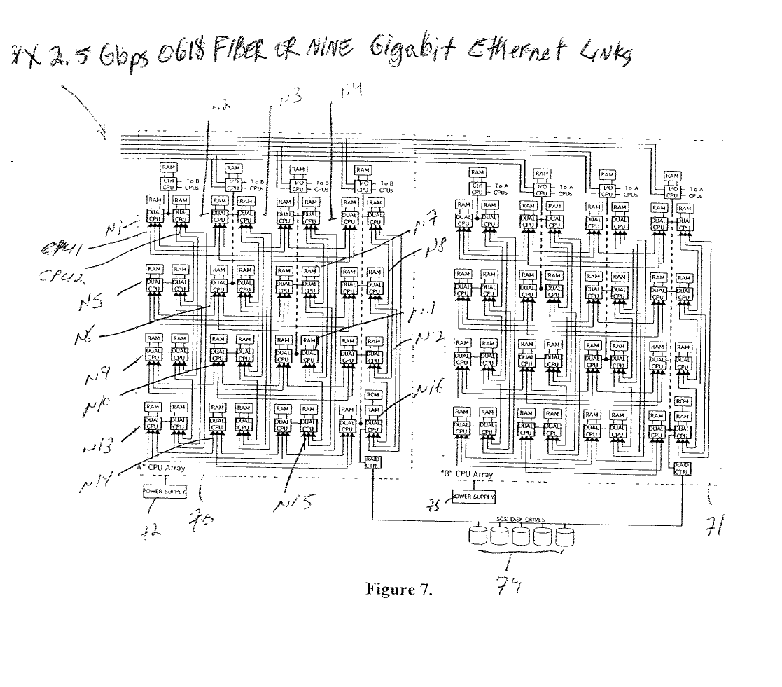

FIG. 7 is a block schematic diagram showing a PLEX implementation of a server farm according to the invention (see T. Calderone, M. Foster, System, Method, and Node of a Multi-Dimensional Plex Communication Network and Node Thereof, U.S. patent application Ser. No. 09/679,115 (Oct. 4, 2000)). For purposes of the discussion herein, PLEX refers to a topology. In FIG. 7, two arrays 70, 71 are shown which establish a server farm. Also shown are power supplies 72, 73 for each respective array and a bank of disk drives 74.

Each node (for example, see array “A”) N1-N16 has two integrated circuits CPU1, CPU2, each of which has a total of three interfaces are standard network interfaces and one interface (LDT) is not. Three of the interfaces are used to establish a PLEX topology and the fourth interface couples the two CPUs together. FIG. 7 depicts two arrays, where each array is a two-dimensional NxM PLEX communication grid with N=4 nodes, each node containing six ports, and having two communications processors, as described above. Such topology is a typical PLEX topology. Those skilled in the art will appreciate that the invention herein is readily applicable to other topologies, including both other PLEX topologies and non-PLEX topologies. This embodiment of the invention uses the PLEX arrays as very powerful servers, where two or more of such arrays are configured to provide a server farm.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A network architecture, comprising:
a server farm comprised of a plurality of systems-on-a-chip;
each system-on-a-chip implementing one or more integrated standard or other network interfaces; and
an interconnect scheme for connecting said system-on-a-chip via said network interfaces, wherein said interconnect scheme eliminates physical interfaces that are otherwise required to establish communications between servers in a server farm.

2. The network architecture of claim 1, said interconnect scheme comprising a point-to-point scheme.

3. The network architecture of claim 1, said standard network interface comprising Ethernet.

4. The network architecture of claim 1, said interconnect scheme comprising a back plane comprising a plurality of connectors.

5. The network architecture of claim 1, said systems-on-a-chip being interconnected to define two or more PLEX arrays.

6. A data communications network, comprising:
a standard networking component for implementing a standard data communications network;
a plurality of systems-on-a-chip that each comprise at least one processor and that each provide one or more standard network interfaces;
a plurality of servers, each of said servers defined by one or more systems-on-a-chip; and
a plurality of servers connected by said standard data communications network to define a server farm; and
an interconnect scheme for connecting said systems-on-a-chip via said network interfaces, wherein said interconnect scheme eliminates physical interfaces that are otherwise required to establish communications between servers in said server farm.

7. The network of claim 6, said interconnect scheme comprising a point-to-point scheme.

8. The network of claim 6, said standard network interface comprising Ethernet.

9. The network of claim 6, said interconnect scheme comprising a back plane comprising a plurality of connectors.

10. The network of claim 6, said systems-on-a-chip being interconnected to define two or more PLEX arrays.

11. A network interconnection method, comprising the steps of:
providing a server farm comprised of a plurality of systems-on-a-chip;
each system-on-a-chip implementing one or more integrated standard or other network interfaces; and
providing an interconnect scheme for connecting said system-on-a-chip via said network interfaces, wherein said interconnect scheme eliminates physical interfaces that are otherwise required to establish communications between servers in a server farm.

12. The method of claim 11, said interconnect scheme comprising a point-to-point scheme.

13. The method of claim 11, said standard network interface comprising Ethernet.

14. The method of claim 11, said interconnect scheme comprising a back plane comprising a plurality of connectors.

15. The method of claim 11, said systems-on-a-chip being interconnected to define two or more PLEX arrays.

16. A data communications method, comprising the steps of:
implementing a standard data communications network with a standard networking component;
providing a plurality of systems-on-a-chip that each comprise at least one processor and that each provide one or more standard network interfaces;
providing a plurality of servers, each of said servers defined by one or more systems-on-a-chip; and
connecting a plurality of said servers by said standard data communications network to define a server farm.

17. The method of claim 16, further comprising:
an interconnect scheme for connecting said systems-on-a-chip via said network interfaces, wherein said interconnect scheme eliminates physical interfaces that are otherwise required to establish communications between servers in said server farm.

18. The method of claim 17, said interconnect scheme comprising a point-to-point scheme.

19. The method architecture of claim 16, said standard network interface comprising Ethernet.

20. The method architecture of claim 17, said interconnect scheme comprising a back plane comprising a plurality of connectors.

21. The method architecture of claim 16, said systems-on-a-chip being interconnected to define two or more PLEX arrays.
